(19) United States
(12) Patent Application Publication
(10) Pub. No.: US 2021/0082000 A1
(43) Pub. Date: Mar. 18, 2021

(54) SYSTEM AND METHOD FOR ENHANCING MEDIA ASSET FILES FOR WEB PLATFORMS

(71) Applicant: My Web IT, LLC, White Lake, MI (US)

(72) Inventors: Richard Laframboise, Lexington, MI (US); J.S. de Jong, Giesbeek (NL)

(21) Appl. No.: 17/024,091

(22) Filed: Sep. 17, 2020

Related U.S. Application Data
(60) Provisional application No. 62/901,574, filed on Sep. 17, 2019.

(51) Int. Cl. G06Q 30/02; G06Q 30/04; G06F 16/48; G06F 16/432

(52) U.S. Cl. CPC G06Q 30/0276; G06F 16/434; G06F 16/48; G06Q 30/04

(57) ABSTRACT

A method for enhancing a media asset file corresponding to a product is provided. The method includes receiving the media asset file for uploading on an ecommerce platform and performing the enhancement of the media asset file. The method also includes displaying the enhanced media asset file and the original media asset file to a user. Furthermore, the method includes receiving a user input corresponding to a selection of one of the enhanced media asset file or the original media asset file, and uploading the enhanced media asset file at the ecommerce platform if the user selects the enhanced media asset file.

### FIELD OF THE PRESENT DISCLOSURE

The present disclosure relates to image processing and, more particularly, to a system and a method for enhancing media asset files to be submitted to web platforms, like ecommerce websites.

### BACKGROUND

Generally, with an increase in use of technology in daily lives, particularly with use of smartphones and other electronic devices for day-to-day activities, there has been a corresponding increase in online transactions that are performed using the portable electronic devices. For example, it has become extremely convenient for users of various ecommerce platforms to purchase different products with just a few clicks, from the comfort of their own homes, offices and so forth. Furthermore, unlike with traditional brick-and-mortar stores, it has become extremely easy for sellers to sell different products through such ecommerce platforms by showcasing attractive features associated with the products through use of text, images, videos and other forms of media assets. Such ecommerce platforms enable the sellers to start transacting quickly and easily after providing important details of the products to be listed for sale (such as, a name, a description, a price and so forth) and by adding one or more images representing the products. In another example, a service-provider associated with home-repair services (such as, mold remediation, collision repair, home remodeling, landscaping, and so forth) can advertise various services on a service-portal or directory. Consequently, the service-provider can employ media assets comprising, for example, “before” and “after” images showing an outcome for a client after using the services. It will be appreciated that such media assets can also be employed for non-commercial transactions, such as, on dating or matrimonial service platforms for representing potential suitors through appealing images thereof. Therefore, such online transactions can include, but is not limited to, sales, marketing, advertising, promotion and endorsement of a tangible item, an entity, a service, a concept and so forth. Furthermore, the online transactions can be performed by marketers, purveyors, promoters, advertisers, endorsers, vendors, and so forth, and may be targeted for individuals, group of individuals, commercial establishments and the like.

Conventionally, a user looking to sell products through an ecommerce platform can conveniently provide various details associated with the products by using his/her electronic device. However, the ecommerce website may require the user to add one or more images that clearly represent the products to be listed for sale. Usually, the user can employ a camera associated with the portable electronic device (such as, a smartphone camera) to capture one or more images representing the product. However, it will be appreciated that the camera associated with the portable electronic device may be incapable of capturing images having sufficient quality to be displayed on the ecommerce website. Further, sometimes, the user may lack sufficient technical skills to edit the captured images to meet the specific image requirements of the ecommerce website. Consequently, it becomes highly troublesome and time-consuming for the user to begin transacting through the ecommerce platform.

Therefore, in light of the foregoing discussion, there exists a need to overcome problems associated with submitting images representing products to ecommerce platforms.

### SUMMARY

In an aspect, a method for enhancing a media asset file corresponding to a product is provided. The method includes receiving, by an enhancement platform, the media asset file for uploading on an ecommerce platform. The method further includes performing the enhancement, by a data processing arrangement, of the media asset. The method also includes displaying, by the enhancement platform, the enhanced media asset file and the original media asset file to a user. Furthermore, the method includes receiving, by the enhancement platform, a user input corresponding to a selection of one of the enhanced media asset file or the original media asset file, and uploading the enhanced media asset file at the ecommerce platform if the user selects the enhanced media asset file.

In another aspect, a system for facilitating an enhancement of a media asset file corresponding to a product is provided. The system includes an ecommerce platform to enable one or more ecommerce transactions, a data processing arrangement for performing the enhancement of the media asset file, and an enhancement platform in communication with the e-commerce platform and the data processing arrangement. The enhancement platform is configured to receive the media asset file from a user device. Further, the enhancement platform is configured to facilitate an enhancement, by the data processing arrangement, of the media asset file. The enhancement platform is also configured to display via the user device the enhanced media asset file and the original media asset file to a user, and to receive a user input corresponding to a selection of one of the enhanced media asset file or the original media asset file. Furthermore, the enhancement platform is configured to upload the enhance media asset file at the ecommerce platform if the user input corresponds to a selection of the enhanced media asset file.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

For a more complete understanding of example embodiments of the present disclosure, reference is now made to the following descriptions taken in connection with the accompanying drawings in which:

FIG. 1 illustrates a system that may reside on and may be executed by a computer, which may be connected to a network, in accordance with one or more exemplary embodiments of the present disclosure;

FIG. 2 illustrates a diagrammatic view of a user device of FIG. 1, in accordance with one or more exemplary embodiments of the present disclosure;

FIG. 3 illustrates a system for enhancing a media asset file to be submitted to an ecommerce platform, in accordance with one or more embodiments of the present disclosure; and

FIG. 4 shows a flowchart illustrating steps of a method for enhancing a media asset file to be submitted to an ecommerce platform, in accordance with one or more embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure is not limited to these specific details.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments.

The present disclosure relates to image processing and more specifically, to a system and a method for enhancing media asset files to be submitted to ecommerce platforms. In particular, the present disclosure provides an algorithm of interaction between a user and a system to enable an automatic or semi-automatic enhancement of the media and simultaneous submission of the media to any e-commerce platform. The e-commerce platform is integrated with the front end platform and has an improvement service for enhancement of the submitted media. The integrated front end platform interacts with the user and sends media to the improvement service. The improvement service uses computational or the enhancement processes and returns the processed data to the integrated front end platform.

In some implementations, the present disclosure may be embodied as a system, method, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as JavaScript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures. For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

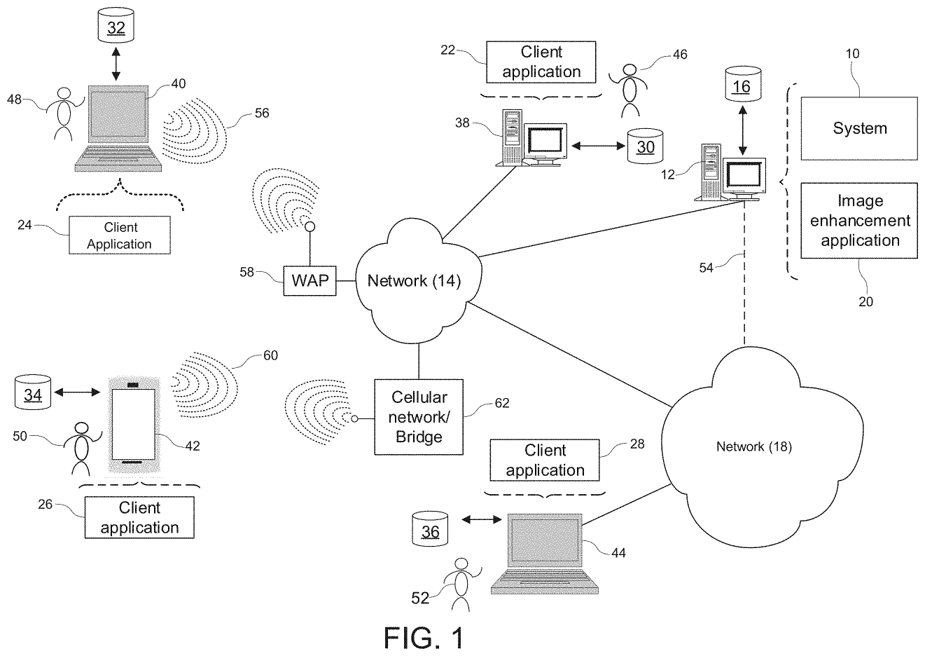

Referring now to the example implementation of FIG. 1, there is shown a system 10 that may reside on and may be executed by a computer (e.g., computer 12), which may be connected to a network (e.g., network 14) (e.g., the internet or a local area network). Examples of computer 12 may include, but are not limited to, a personal computer(s), a laptop computer(s), mobile computing device(s), a server computer, a series of server computers, a mainframe computer(s), or a computing cloud(s). In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, the instruction sets and subroutines of system 10, which may be stored on storage device, such as storage device 16, coupled to computer 12, may be executed by one or more processors (not shown) and one or more memory architectures included within computer 12. In some implementations, storage device 16 may include but is not limited to: a hard disk drive; a flash drive, a tape drive; an optical drive; a RAID array (or other array); a random access memory (RAM); and a read-only memory (ROM).

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, system 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute image enhancement application 20 for billing a project. In some implementations, system 10 and/or image enhancement application 20 may be accessed via one or more of client applications 22, 24, 26, 28. In some implementations, system 10 may be a standalone application, or may be an applet/application/script/extension that may interact with and/or be executed within image enhancement application 20, a component of image enhancement application 20, and/or one or more of client applications 22, 24, 26, 28. In some implementations, image enhancement application 20 may be a standalone application, or may be an applet/application/script/extension that may interact with and/or be executed within system 10, a component of system 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of system 10 and/or image enhancement application 20. Examples of client applications 22, 24, 26, 28 may include, but are not limited to, a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to user devices 38, 40, 42, 44, may be executed by one or more processors and one or more memory architectures incorporated into user devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of user devices 38, 40, 42, 44 (and/or computer 12) may include, but are not limited to, a personal computer (e.g., user device 38), a laptop computer (e.g., user device 40), a smart/data-enabled, cellular phone (e.g., user device 42), a notebook computer (e.g., user device 44), a tablet (not shown), a server (not shown), a television (not shown), a smart television (not shown), a media (e.g., video, photo, etc.) capturing device (not shown), and a dedicated network device (not shown). User devices 38, 40, 42, 44 may each execute an operating system, examples of which may include but are not limited to, Android®, Apple® iOS®, Mac® OS X®; Red Hat® Linux®′ or a custom operating system.

In some implementations, system 10 may be a hybrid server-side/client-side application that is cooperatively executed by one or more of client applications 22, 24, 26, 28 and/or system 10.

In some implementations, one or more of client applications 22, 24, 26, 28 may be configured to effectuate some or all of the functionality of image enhancement application 20 (and vice versa). Accordingly, in some implementations, image enhancement application 20 may be a purely server-side application, a purely client-side application, or a hybrid server-side/client-side application that is cooperatively executed by one or more of client applications 22, 24, 26, 28 and/or image enhancement application 20. As one or more of client applications 22, 24, 26, 28, system 10, and image enhancement application 20, taken singly or in any combination, may effectuate some or all of the same functionality, any description of effectuating such functionality via one or more of client applications 22, 24, 26, 28, system 10, image enhancement application 20, or combination thereof, and any described interaction(s) between one or more of client applications 22, 24, 26, 28, system 10, image enhancement application 20, or combination thereof to effectuate such functionality, should be taken as an example only and not to limit the scope of the disclosure.

In some implementations, one or more of users 46, 48, 50, 52 may access computer 12 and system 10 (e.g., using one or more of user devices 38, 40, 42, 44) directly through network 14 or through secondary network 18. Further, computer 12 may be connected to network 14 through secondary network 18, as illustrated with phantom link line 54. System 10 may include one or more user interfaces, such as browsers and textual or graphical user interfaces, through which users 46, 48, 50, 52 may access system 10.

In some implementations, the various user devices may be directly or indirectly coupled to network 14 (or network 18). For example, user device 38 is shown directly coupled to network 14 via a hardwired network connection. Further, user device 44 is shown directly coupled to network 18 via a hardwired network connection. User device 40 is shown wirelessly coupled to network 14 via wireless communication channel 56 established between user device 40 and wireless access point (i.e., WAP) 58, which is shown directly coupled to network 14. WAP 58 may be, for example, an IEEE 802.11a, 802.11b, 802.11g, Wi-Fi®, RFID, and/or Bluetooth™ (including Bluetooth™ Low Energy) device that is capable of establishing wireless communication channel 56 between user device 40 and WAP 58. User device 42 is shown wirelessly coupled to network 14 via wireless communication channel 60 established between user device 42 and cellular network/bridge 62, which is shown directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

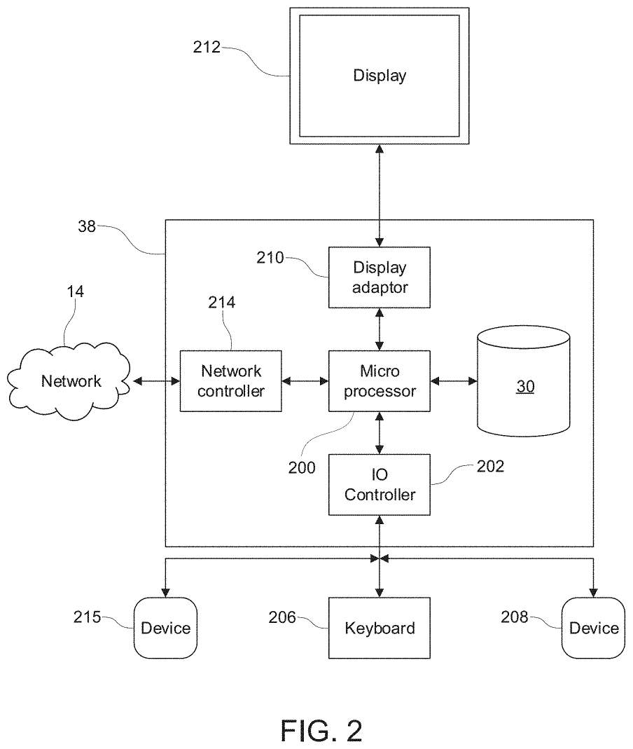

Referring also to the example implementation of FIG. 2, there is shown a diagrammatic view of user device 38. While user device 38 is shown in this figure, this is for example purposes only and is not intended to be a limitation of this disclosure, as other configurations are possible. Additionally, any computing device capable of executing, in whole or in part, system 10 may be substituted for user device 38 (in whole or in part) within FIG. 2, examples of which may include but are not limited to computer 12 and/or one or more of user devices 38, 40, 42, 44.

In some implementations, user device 38 may include a processor and/or microprocessor (e.g., microprocessor 200) configured to, e.g., process data and execute the above-noted code/instruction sets and subroutines. Microprocessor 200 may be coupled via a storage adaptor (not shown) to the above-noted storage device(s) (e.g., storage device 30). An I/O controller (e.g., I/O controller 202) may be configured to couple microprocessor 200 with various devices, such as keyboard 206, pointing/selecting device (e.g., touchpad, touchscreen, mouse 208, etc.), additional device 215, USB ports (not shown), and printer ports (not shown). A display adaptor (e.g., display adaptor 210) may be configured to couple display 212 (e.g., touchscreen monitor(s), plasma, CRT, or LCD monitor(s), etc.) with microprocessor 200, while network controller/adaptor 214 (e.g., an Ethernet adaptor) may be configured to couple microprocessor 200 to the above-noted network 14 (e.g., the Internet or a local area network).

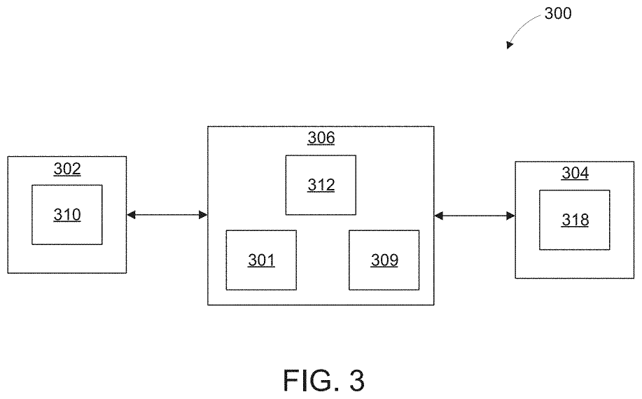

Referring now to FIG. 3, there is shown an environment or system 300 for enhancing a media asset file to be submitted to an ecommerce platform 301, in accordance with one or more embodiments of the present disclosure. The environment 300 comprises a data processing arrangement 302. Herein, the data processing arrangement 302 may be embodied as (or implemented in) the system 10, as shown in FIG. 1. The data processing arrangement 302 enables a user to submit the media asset file to the ecommerce platform 301, such that the media asset file is enhanced as compared to a corresponding original media asset file. The term “media asset file” as used throughout the present disclosure, relates to a creative/digital asset that can be employed for digital representation of one or more creative or adaptable media elements, including but not limited to, text, graphics, drawing, photo, images, renderings, vector graphics (possibly videos), animation, audio, presentation, and any other form of media elements. The media asset files can be processed, stored, transmitted, presented or represented digitally. In an example, the media asset files can be employed for the purpose of showing product or item overview or its features associated with a commercial offer, directory listings or advertising. In another example, the media asset file can comprise a photographic file, a digital image, a product rendering, digital files comprising vector graphics, a frame of a digital video, and so forth. Furthermore, when the media asset file is a digital image, the enhancement of the original media asset file can comprise performing image processing of the original media asset file to increase a resolution of the digital image, change a color tone of the digital image, increase or decrease a sharpness associated with the digital image, and so forth.

The environment 300 comprises a user device 304. As shown, each of the user device 304 and the data processing arrangement 302 are communicatively coupled to an ecommerce system 306. The user device 304 can be implemented as a computing device (such as, the user device 42, as shown in FIG. 1), such that the computing device is capable of capturing an image of a product. The image of the product can be used by the user to make a listing for sale of the product on the ecommerce platform 301, start an advertising campaign for the product, list for availability of the product on a corresponding directory (such as, a product directory associated with a location of the user), and so forth. Consequently, the user device 304 comprises a camera unit 308 that is capable of capturing a digital image (or a digital video) of the product. It will be appreciated that the digital image of the product that is captured using the camera unit 308 may not be associated with a high image quality. For example, artifacts may get introduced into the captured image, such that the artifacts may comprise a lighting artifact, a movement artifact, and so forth. Consequently, when the digital image is used on the ecommerce platform 301 (or in the advertising campaign, for making the directory listing, and so forth) for representing the product, the product may not be conveniently discernible within the image. Furthermore, the ecommerce platform 301 may require the user to submit the image having a particular image resolution, a specific color tone, and so forth. It will be appreciated that the user device 304 may not be capable of enhancing the captured digital image to provide the image having the specified image resolution, color tone, and so forth as required by the ecommerce platform 301.

The environment 300 comprises the ecommerce system 306 communicatively coupled to the user device 304. In some implementations, the ecommerce system 306 can be implemented using a server arrangement. For example, the ecommerce system 306 may be implemented as a cloud server. In some implementations, the ecommerce system 306 can comprise a data storing arrangement (not shown). Furthermore, each of the ecommerce system 306 and the user device 304 can be coupled to a network (such as the network 14 shown in FIG. 1) via wireless communication channel (such as the wireless communication channel 56 established between user device 40 and WAP 58 shown in FIG. 1).

The ecommerce system 306 is configured to host the ecommerce platform 301 (i.e. ecommerce website), to enable ecommerce transactions between various users. For example, the ecommerce platform 301 enables users to list products for sale, purchase the products listed for sale, create user-accounts for purchasing and/or selling products, interact with other users (such as, through electronic messages) to facilitate the ecommerce transactions, and so forth. Furthermore, the ecommerce system 306 is configured to host an enhancement platform 309 for enabling enhancement of media asset files uploaded by users of the ecommerce platform 301. The enhancement platform 30 is communicatively coupled to the ecommerce platform 301. Consequently, a user looking to offer one or more products for sale through the ecommerce platform 301 (such as) may be required to register for a user-account (for example, a seller-account) with the ecommerce platform 301. Subsequently, the user can begin to add product listings corresponding to the one or more products on the ecommerce platform 301. It will be appreciated that the user may be required to provide information corresponding to each product to be listed on the ecommerce platform 301 for sale, including but not limited to, a title (or name) of the product, a description of the product, one or more features associated with the product, a price of the product, shipping charges for shipping the product to various destinations, guarantee/warranty information associated with the product, and so forth. Furthermore, the user may be required to provide one or more images associated with the product, such that each image of the one or more images represents a different physical view (for example, a top-view, a front view, a side-view and so forth) of the product to be listed for sale. Consequently, the user uses the camera unit 308 associated with the user device 304 to capture the one or more images of the product.

Furthermore, the one or more images of the product are transmitted to the ecommerce system 306 via the network. In some implementations, the user device 304 is configured to receive a user-input prior to transmitting the one or more images to the ecommerce system 306. For example, the user may be required to provide an authorization code and/or click a button (such as, an ‘upload’ button presented on a graphical user interface or GUI presented on the user device 304) to initiate the transmission of the one or more images to the ecommerce system 306. Subsequently, the one or more images transmitted to the ecommerce system 306 are provided to the enhancement platform 309 for performing enhancement thereof. In an embodiment, the user may be presented with a selection button to provide an option to the user for sending the one or more images to the enhancement platform 309 for performing enhancement thereof. In such a case, the one or more images are transmitted to the enhancement platform 309 only if the user clicks on the selection button. In one or more implementations, the enhancement platform 309 is configured to determine if the one or more images transmitted by the user can be enhanced. For example, the one or more images may be associated with a file-format that can cannot be processed for enhancement. In another example, the one or more images may be associated with an image quality (such as, image resolution or color tone) that cannot be used for discerning presence of one or more products therein. In such examples, the ecommerce system 306 is configured to provide a notification on the user device 304 that the one or more images cannot be enhanced. Additionally, the ecommerce system 306 can be configured to require the user to submit replacement images corresponding to each of such one or more images that cannot be enhanced.

Moreover, the environment 300 comprises the data processing arrangement 302 that is communicatively coupled to the ecommerce system 306. As shown, the data processing arrangement 302 comprises an application programming interface (API) 310 that is configured to communicate with an API 312 associated with the ecommerce system 306. The data processing arrangement 302 is configured to receive one or more images of the product and any other data, as uploaded by the user on the ecommerce system 306 via the user device 304, via the API 310 in communication with the API 312 of the ecommerce system 306. Herein, the ecommerce system 306 may act as the front-end interface and the data processing arrangement 302 may be the back-end data processing platform. The environment 300 defines the user and/or the ecommerce system 306 as the content provider(s), and the user interacts with the integrated front end platform of the data processing arrangement 302 via the user device 308 thereof.

The data processing arrangement 302 is configured to host thereon, one or more software modules that are capable of performing image processing of images to enable enhancement of the images. For example, a software module hosted on the data processing arrangement 302 adjusts (such as, increases or decreases) an image resolution of the images. In such an example, the software module may be configured to perform upsampling to increase the image resolution of the images or downsampling to decrease the image resolution of the images. In another example, a software module hosted on the data processing arrangement 302 adjusts a color tone of the images. In such an example, the software module may be configured to employ one or more color filters to change a color and/or color-gradient of the images. In yet another example, a software module hosted on the data processing arrangement 302 is configured to resize an image to correspond to required dimensions. It will be appreciated that various properties associated with an image can be altered by employing one or more image processing techniques that are known in the art.

In some implementations, the user provides a multimedia asset file (including, but not limited to, a word-processor file, a portable document format file, and so forth) comprising one or more media asset files (such as, image files, vector graphics and so forth) to the enhancement platform 309 via the user device 304. For example, the user device 304 is a laptop computer having the multimedia asset file stored on a non-volatile memory unit associated therewith. In such an example, the multimedia asset file is transmitted from the non-volatile memory unit to the enhancement platform 309 by the user device 304 via the network. Subsequently, the enhancement platform 309 is configured to anonymously extract the one or more media asset files from the multimedia asset file. It may be understood that the one or more files are extracted in a manner to discard any information related to personal identification associated with a user of the user device 304. Thereafter, the enhancement platform 309 is configured to send the extracted one or more media asset files for enhancement thereof to the data processing arrangement 302.

Generally, each media asset file transmitted by the user device 304 to the enhancement platform 309 comprises metadata. Such metadata can include, but is not limited to, a title, a description, a unique identifier (such as, a universal resource locator or URL), device-identifier associated with the camera unit 308 used to capture the media asset file, one or more keywords, and so forth. Correspondingly, the enhancement platform 309 is configured to transmit such metadata along with the media asset file to the data processing arrangement 302, to enable the data processing arrangement 302 to uniquely and anonymously identify each media asset file. In some implementations, a software module hosted on the data processing arrangement 302 is configured to perform optical character recognition of one or more alphanumeric strings displayed on the media asset file. Subsequently, the data processing arrangement 302 is configured to use the recognized alphanumeric strings as metadata (such as, as one or more keywords or as a description) for the media asset file. Furthermore, the data processing arrangement 302 may utilize such metadata information to extract information for categorizing the product captured in the media asset file, and may execute specific image enhancement techniques related to that particular category of product.

Furthermore, the user device 304 is configured to receive a preference for each enhancement to be performed to the media asset file. The term “preference” as used throughout the present disclosure with respect to the enhancement to be performed, relates to a global default, a site-level default, determined or selected by a site, a user default (such as, based on information associated with a user-profile corresponding to each user), determined or selected by artificial-intelligence or algorithm (such as, through machine-learning algorithms), determined using a specific rule set, through a combination of two or more of the aforementioned criteria, and so forth.

In one or more implementations, the user device 304 is configured to receive a user-input from the user indicating a preference for each enhancement to be performed to the media asset file. For example, the user-input may correspond to increasing a sharpness of an image, changing a temperature of the image or increasing a saturation associated with the image. In such an example, the user-input may be received on a GUI presented on the user device 304. The preference for the enhancement to be performed to the media asset file is transmitted, along with the metadata to the enhancement platform 309 associated with the ecommerce system 306 and subsequently, to the data processing arrangement 302.

The software modules hosted on the data processing arrangement 302 are configured to perform file-compression of the media asset file. Subsequently, the software modules are configured to perform image processing of the media asset file, such that the image processing leads to enhancement of the media asset file based on the preference (such as, based on the user-input received from the user). In some implementations, the software modules are configured to determine an optimized enhancement (such as, an optimized image resolution, optimized color tone and so forth) for each media asset file, based on the metadata associated with the media asset file and the preference for the enhancement to be performed. Subsequently, the software modules are configured to perform file-compression of the media asset file and thereafter, perform the optimized enhancement of the media asset file.

The data processing arrangement 302 is configured to transmit one or more enhanced media asset files to the enhancement module hosted on the ecommerce system 306, such that each enhanced media asset file corresponds to a different preference (or a different set of preferences). For example, a user provides a preference for increasing a sharpness associated with the image. Furthermore, the user provides a preference for changing a color tone of the image to receive a grayscale image having the increased sharpness. In such an example, data processing arrangement 302 is configured to transmit two different enhanced images to the enhancement platform 309, such that one image corresponds to a compressed-file of the grayscale image having the increased sharpness and another image corresponds to a compressed-file of the original color image having the increased sharpness.

Furthermore, the enhancement platform 309 is configured to display the enhanced images along with the original media asset file, on a GUI presented on the user device 304. For example, the GUI is associated with a web-browser presented on the user device 304. In such an example, each of the enhanced images and the original media asset file are displayed on the web-browser as thumbnails. In some implementations, the enhanced image and the original media asset file are displayed in full view rather than as the thumbnails. Moreover, the enhancement platform 309 is configured to receive a user-input for selecting one of the enhanced images or the original media asset file. The user-input is received on a GUI presented on the user device 304, such as, by requiring the user to click on one of the displayed images. For example, when the user is presented with thumbnails of the compressed-file of the grayscale image having the increased sharpness, the compressed-file of the color image having the increased sharpness, and the corresponding original media asset file, the user may provide the user-input to select the compressed-file of the color image having the increased sharpness. Consequently, the enhancement platform 309 is configured to transmit data corresponding to the selection to the data processing arrangement 302.

Furthermore, in response to the selection made by the user, the data processing arrangement 302 is configured to perform a corresponding enhancement of a full-size media asset file that is originally transmitted by the enhancement platform 309. In the above example, in response to the user selecting the compressed-file of the color image having the increased sharpness, the software modules hosted on the data processing arrangement 302 are configured to increase the sharpness of the image that is originally transmitted by the enhancement platform 309 to the data processing arrangement 302 (such that the original image is a color image, thereby, not requiring any change in color tone). Subsequently, the data processing arrangement 302 is configured to transmit the enhanced full-size image to the enhancement platform 309. Thereafter, the enhancement platform 309 is configured to transmit the enhanced full-size image to the ecommerce platform 301, to be displayed on the ecommerce platform 301 for representing a corresponding product.

In some implementations, each of the ecommerce system 306 and the data processing arrangement 302 is configured to host a software module therein, such that the software module maintains a billing function. The software module that maintains the billing function within the data processing arrangement 302 is configured to track enhancements of various images and corresponding selections of enhanced images made by users of the ecommerce system 306. Furthermore, the software module maintaining the billing function on the ecommerce system 306 is configured to track various enhanced images received from the data processing arrangement 302 and corresponding selections of enhanced images made by users. Consequently, when the user selects the enhanced image transmitted from the data processing arrangement 302 to the enhancement platform 309, the software module that maintains the billing function on the data processing arrangement 302 is configured to update the software module maintaining the billing function on the ecommerce system 306, about a cost incurred for the performed enhancement.

Alternatively, if the user selects the image originally transmitted by the enhancement platform 309 instead of one of the enhanced images, then it may be concluded that no enhancement is performed by the software modules hosted on the data processing arrangement 302. Thereafter, the enhancement platform 309 is configured to transmit the original full-size image to the ecommerce platform 301, to be displayed on the ecommerce platform 301 for representing a corresponding product. Consequently, the corresponding software modules that maintain the billing function do not update any costs associated with performing enhancement of images.

In some implementations, the data processing arrangement 302 is configured to collect anonymous data corresponding to selections of enhanced images made by various users, metadata associated with the corresponding media asset files, and so forth. Such anonymous data is employed by the data processing arrangement 302 to improve the software modules that perform the enhancement of media asset files. For example, the anonymous data is employed by the software modules hosted on the data processing arrangement 302 for optimizing enhancement (as explained herein above) of the media asset files. It may be appreciated that for such purposes the data processing arrangement 302 may employ machine learning algorithms, executed on neural network platforms and the like. Such techniques are known in the art and thus have not been described herein for the brevity of the present disclosure. Further, in certain implementations, the enhancement platform 309 may be omitted, and in such a case, the data processing arrangement 302 may perform all the functionalities performed by the enhancement platform 309.

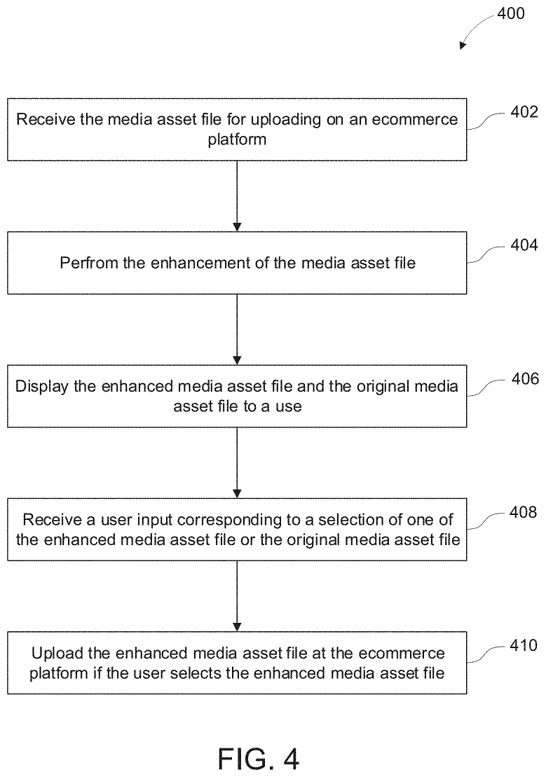

Referring to FIG. 4, there is shown a flowchart illustrating steps of a method 400 for enhancing a media asset file to be submitted to an ecommerce platform 301, in accordance with one or more embodiments of the present disclosure. At a step 402, the enhancement platform receives the media asset file, such that the media asset file represents a product. In an embodiment, the enhancement platform 309 receives the media asset file if the user selects for enhancement of the media asset file. For enabling the user to choose/select for enhancement of the media asset file, a selection button may be provided to the user via the GUI displayed on the user device 304. Thereafter, the enhancement platform 309 may transmit the media asset file to the data processing arrangement 302.

At a step 404 of the method 400, the data processing arrangement 302 performs enhancement of the media asset file. In an embodiment, the data processing arrangement 302 may utilize the metadata associated with the media asset file for optimizing the enhancement. In certain implementations, the data processing arrangement 302 may perform enhancement of the media asset file based on a preference. In an embodiment, the preference may be a user defined preference. The user may input/provide the preference during uploading of the media asset file to the ecommerce system 306. In an embodiment, before proceeding with the enhancement of the media asset file, the data processing arrangement 302 may compress the media asset file and may perform the enhancement on the compressed media asset file. In certain implementation, the enhancement platform 309 may compress the media asset file and transmit/share the compressed media asset file to the data processing arrangement 302 for performing enhancement on the compressed media asset file. Subsequently, the data processing arrangement 302 may transmit the enhanced media asset file to the enhancement platform 309.

Subsequently, at a step 406 of the method 400, the enhanced media asset file and the original media asset file are displayed to the user. In an embodiment, the user may be presented with the compressed enhanced media asset file and the compressed original media file. Thereafter, the method 400 moves to a step 408. At the step 408, a selection is received from the user, such that the selection corresponds the enhanced media asset file or the original media asset file. In an embodiment, the data processing arrangement 302 may determine a cost associated with the enhancement of the media asset file if the user selects the enhanced media asset file and display the cost of enhancement to the user before uploading the enhanced media asset file. In certain implementations, the cost for the enhancement is displayed to the user when the enhanced media asset file and the original media asset file are displayed to the user for selection at the step 406.

Further, at a step 410 of the method 400, the enhancement platform 309 facilitates an uploading of the enhanced media asset file at the ecommerce platform 301 if the user selects the enhanced media asset file at the step 408. Alternatively, the original medial asset file is uploaded on the e-commerce platform 301. In a scenario in which the compressed enhanced media file is presented to the user for selection, the data processing arrangement 302 preforms the enhancement on the uncompressed media asset file upon selection of the compressed enhanced media asset file by the user. Subsequently, the enhanced media asset file is uploaded on the ecommerce platform 301. Thereafter, the cost for the enhancement is billed to the user. In an embodiment, the cost is billed to the user when the product is sold.

The present disclosure provides means of interaction between the user and systems to enable an automatic or semi-automatic enhancement services for illustrations (images) in the media asset files in parallel to item submission process to any e-commerce platform. Herein, the image enhancement service may apply the internal process which takes under consideration the media itself, its features and description and optimizes settings for best image enhancement (e.g., photo toning) to be applied. Herein, the image enhancement service enhances the illustration media based on multiple variables and accordingly optimizes enhancement settings (e.g. best photo toning to be applied). For example, the image enhancement service reduces the size of original media before performing media enhancement and delivers one or more proposed variants of enhanced media to e-commerce platform.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

1-3. (canceled)

4. A method for enhancing a media asset file corresponding to a product, the method comprising:
receiving, by an enhancement platform, the media asset file for uploading on an ecommerce platform;
performing the enhancement, by a data processing arrangement, of the media asset file;
displaying, by the enhancement platform, the enhanced media asset file and the original media asset file to a user;
receiving, by the enhancement platform, a user input corresponding to a selection of one of the enhanced media asset file or the original media asset file; and
uploading the enhanced media asset file at the ecommerce platform if the user selects the enhanced media asset file.

5. The method of claim 4, wherein receiving the media asset file includes receiving a metadata associated with the media asset file.

6. The method of claim 5, wherein the data processing arrangement performs the enhancement based on the metadata.

7. The method of claim 6, wherein the metadata associated with the media asset file includes at least one of a title the media asset file, a description the media asset file, a unique identifier the media asset file, or a device-identifier associated with the media asset file.

8. The method of claim 4 further including
receiving, by the data processing arrangement, a preference for enhancement to be performed on the media asset file, and
performing the enhancement, by the data processing arrangement, of the media asset file based on the preference.

9. The method of claim 8, wherein the preference is a user preference provided by the user.

10. The method of claim 8, wherein the preference corresponds to at least one of a sharpness of an image, a temperature of an image, or a color tone of an image.

11. The method of claim 4, wherein the enhancement platform receives the media asset file if the user selects for enhancement of the media asset file.

12. The method of claim 4, wherein displaying the enhanced media asset file and the original media asset file includes displaying a thumbnail of the enhanced media asset file and a thumbnail of the original medial asset file.

13. The method of claim 4, further comprising determining a cost associated with the performed enhancement if the selection corresponds to the enhanced media asset file.

14. A system for facilitating an enhancement of a media asset file corresponding to a product, comprising:
an ecommerce platform to enable one or more ecommerce transactions;
a data processing arrangement for performing the enhancement of the media asset file; and
an enhancement platform in communication with the e-commerce platform and the data processing arrangement, the enhancement platform configured to:
receive the media asset file from a user device;
facilitate an enhancement, by the data processing arrangement, of the media asset file;
display via the user device the enhanced media asset file and the original media asset file to a user;
receive a user input corresponding to a selection of one of the enhanced media asset file or the original media asset file; and
upload the enhance media asset file at the ecommerce platform if the user input corresponds to a selection of the enhanced media asset file.

15. The system of claim 14, wherein receiving the media asset file includes receiving a metadata associated with the media asset file.

16. The system of claim 15, wherein the data processing arrangement performs the enhancement based on the metadata.

17. The system of claim 16, wherein the metadata associated with the media asset file includes at least one of a title the media asset file, a description the media asset file, a unique identifier the media asset file, or a device-identifier associated with the media asset file.

18. The system of claim 14, further comprising:
receiving, by the data processing arrangement, a preference for enhancement to be performed on the media asset file, and
performing the enhancement, by the data processing arrangement, of the media asset file based on the preference.

19. The system of claim 18, wherein the preference is a user preference provided by the user via the user device.

20. The system of claim 18, wherein the preference corresponds to at least one of a sharpness of an image, a temperature of an image, or a color tone of an image.

21. The system of claim 18, wherein the enhancement platform receives the media asset file if the user selects for enhancement of the media asset file.

22. The system of claim 14, wherein displaying the enhanced media asset file and the original media asset file includes displaying a thumbnail of the enhanced media asset file and a thumbnail of the original medial asset file.

23. The system of claim 14, further comprising: determining, by the data processing arrangement, a cost associated with the performed enhancement if the selection corresponds to the enhanced media asset file.
